(19) United States
(12) Patent Application Publication
(10) Pub. No.: US 2009/0228279 A1
(43) Pub. Date: Sep. 10, 2009

(54) Recording of an audio performance of media in segments over a communication network

(75) Inventors: Janet H. Kephart, Denver, CO (US); Leigh Steere, Superior, CO (US); Jafar Nabkel, Longmont, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: TANDEM READERS, LLC, Denver, CO (US)

(21) Appl. No.: 12/147,695

(22) Filed: Jun. 27, 2008

Related U.S. Application Data
(63) Continuation-in-part of application No. 12/044,627, filed on Mar. 7, 2008.
Application No. 12/044,627 is a continuation-in-part of application No. 12/057,136, filed on Mar. 27, 2008.
Application No. 12/057,136 is a continuation-in-part of application No. 12/109,250, filed on Apr. 24, 2008.

(51) Int. Cl. G10L 21/00

(52) U.S. Cl. 704/270; 704/E21.001

(57) ABSTRACT

An audio performance of a media selection is recorded in segments over a communication network. A sender obtains a copy of a media selection that may be divided into media segments for audio recording. The sender can annotate and record a reading of each media segment and any additional commentary. The audio data constituting the “audio performance” is transmitted from a sender telephony device over the communication network to a voice server. The segments of audio data may be collected and arranged in order and assembled with prerecorded segment cues. The audio segments may also be synchronized with digital copies of the media segments. In one implementation, a user, for example, a grandparent, can read a children's book into a telephony device, including personal anecdotes, for page-by-page recording over the communication network for storage at a voice server for later fulfillment to a grandchild in conjunction with a copy of the media selection in physical or electronic form.

### CROSS REFERENCE TO RELATED APPLICATIONS

This application is a continuation-in-part of U.S. patent application Ser. No. 12/044,627 filed 7 Mar. 2008 entitled “Synchronized display of media and recoding of audio over a network.” This application is also a continuation-in-part of U.S. patent application Ser. No. 12/057,136 filed 27 Mar. 2008 entitled “Fulfillment of an audio performance recorded across a network based on a media selection.” This application is also a continuation-in-part of U.S. application Ser. No. 12/109,250 filed 24 Apr. 2008 entitled “Synchronization of media display with recording of audio over a telephone network.” Each of these applications is incorporated herein by reference in its entirety.

### BACKGROUND

In modern society, extended families are often separated by great geographic distances due to circumstances of employment locations, retirement decisions, or merely personal preference for location and lifestyle. It may further be difficult for families to physically visit each other regularly due to the significant distance, cost of travel, or health conditions limiting or preventing travel. Modern technologies have helped bridge this divide by increasing the ease of communications between separated family members. The telephone network is the most obvious example. Additionally, computer networks such as the Internet have made it even easier for family members to quickly communicate with each other in many ways and formats. In addition to electronic mail messages and instant messaging, family members can exchange digital photographs and video as well as post such images to a family web site to allow access, viewing, and message posting by any family member. Further, third party service providers, e.g., photographic developers, have created Internet platforms for the presentation and viewing of electronic photo albums that allow families to share visual experiences and perhaps annotate the pictures with text comments. It is in the spirit of this background that the technology disclosed herein was developed as an alternative way for families to share and interact.

The information included in this Background section of the specification, including any references cited herein and any description or discussion thereof, is included for technical reference purposes only and is not to be regarded subject matter by which the scope of the invention is to be bound.

### SUMMARY

The disclosed technology enables a person, using a telephone to record a media selection in segments over a communication network (e.g. a public switched telephone network (PSTN), a mobile telephone over a wireless network, or a voice-over-internet protocol (VoIP) network). The media selection, for example, text (e.g., pages of a book, either printed or in a portable digital form), images, music, or video, may be stored at or accessible by a network server and may be delivered in a tangible form (e.g., as a book) to a sender's physical address. The sender can annotate each media segment and record, in segments as well, e.g., a reading of the text of a book, and any additional commentary including, for example, observations or opinions regarding sound or video media selections, using the telephone. The voice data or recording, i.e., the “audio performance,” may be transferred over the communication network to the network server. The segments of audio may be synchronized with the media segments and assembled with prerecorded segment cues (e.g., “turn the page now”). In one implementation, the audio performance may be synchronized and assembled with a stream of the corresponding media.

In one exemplary implementation, the technology may be used to allow a person, for example, a grandparent, to view the pages of a children's book, to add or edit personal anecdotes, and to read the book for page-by-page recording over a telephone network to a network server for later presentation to a grandchild. Once recorded, the network server may write the audio recording to a physical medium, for example, a compact disk (CD), digital versatile disk (DVD), removable flash memory storage device, analog or digital audio tape, analog or digital video tape, floppy disk, or other portable or removable storage medium. The physical medium may then be packaged with a printed copy of the book and sent to the grandchild. In an alternate embodiment, the grandchild may be provided a web link to download the audio recording, for example, as an MP3 file for presentation on an MP3 compatible device, and listen to the recording while viewing a printed copy of the book. In a further embodiment, the audio recording may be combined with a visual presentation of the pages of the book and stored on a CD or DVD that is packaged and shipped to the grandchild for presentation on a computer or DVD player. In another embodiment, the grandchild may simultaneously listen to the recorded audio while viewing an electronic copy of the book via a web browser. In yet another embodiment, the grandchild may listen to the recorded audio through a telephone (either a traditional analog telephone, wireless telephone, or a VoIP telephone) while viewing a physical or electronic copy of the book.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

FIG. 1 is a schematic diagram of an exemplary system for implementing the recording of an audio performance of media in segments over a communication network.

FIG. 2 is a flow diagram of exemplary operations for making a media selection, recording an audio performance, and synchronizing the audio performance associated with a media selection across a network.

FIG. 3 is a flow diagram of exemplary operations for recording an audio performance associated with a media selection through a telephony device.

FIG. 4 is a flow diagram of operations for one exemplary implementation of fulfillment of a media and audio performance package for a recipient.

FIG. 5 is a flow diagram of operations for an alternative exemplary implementation of fulfillment of a media and audio performance package for a recipient.

FIG. 6 is a schematic diagram of an exemplary computer system for implementing operations for synchronizing the display of media and recording of audio over a network.

### DETAILED DESCRIPTION

The recording of audio may be realized across a communications network linking several pieces of telephony and computer hardware controlled by a combination of standard and special purpose software operating in conjunction to form a distributed system. The system may primarily include a telephone connected via a communication network (e.g., an analog telephone connected via the public switched telephone network (PSTN), a mobile telephone over a wireless network, or a digital VoIP phone connected via the Internet or other similar data network) to a network server that further manages one or more databases. The person who creates an audio recording over the telephone network is referred to herein as the “sender.” Similarly, the person who receives the audio recording, often in conjunction with a book or other media selection, is referred to herein as the “recipient.”

In one exemplary implementation, the network server may present a variety of children's books available for purchase through the communication network. It should be understood that a book is merely one form of media selection and other selections could be made, for example, an audio recording, a video, a periodical, a digital scrapbook, or other media. The sender is provided with a telephony interface, for example, an interactive voice response (IVR) system, a “touch-tone” dual-tone-multi-frequency (DTMF) system, or some other form of telephone input system, through which she is able to browse the available books, select one or more books, and then proceed to check out. Alternatively, a call center with live caller support could facilitate the media purchase by the sender. Payment may be secured though typical means available to telephone purchasers, for example, credit card, debit card, money order, and cash on delivery (COD). The book or books may then be delivered to the sender in hard copy form, for example, a book, CD, flash storage device, or DVD.

Alternatively, a selection of books or other media items may be presented to the sender via a traditional physical catalog or a display in a store. The sender may browse the available books, select one or more items, and then proceed to check out via a mail-in order form, a PTSN telephone ordering system, a store clerk, a web store, or any other known means of purchasing media items. The media item may then be delivered to the sender or taken from the store in hard copy form, for example, a book, CD, flash storage device, or DVD. Alternatively, the sender may already have in her possession a copy of one of the available media items (e.g., a children's book) which she desires to record an audio performance using the system described herein.

Once a media item is selected or purchased and in the sender's possession, the sender may wish to prepare annotations to the media item. Instructions provided along with the purchase of the media item for use in the audio recording system may encourage and facilitate the use of prepared annotations. These annotations may be a list of personal anecdotes, comments about the story, or a complete scripted dialogue the sender wants to record for a future playback by the recipient. These annotations may be prepared separately or the media item may have prepared templates for inserting annotations as well as suggestions for possible comments. Alternatively, the sender may wish to write the annotations on a separate piece or paper or directly into a physical copy of the media item (e.g., in the margins of a book). In one implementation, the sender may actually send the personally annotated book directly to the recipient or to the operator of the system described herein after recording an audio performance of the media item. The operator may package the personally annotated book with a copy of the audio performance described herein or package the personally annotated book alone for physical shipping to the recipient.

Once a sender has reviewed the media item, prepared or added any desired annotations, and is ready to record, the sender may use a telephony device to communicate with the network server and record audio segments through the telephony device corresponding to segments of the media item (e.g., pages of the book). The network server may be equipped with an IVR system, a touch-tone DTMF system, or some other form of telephony input that enables the sender to select the media item and record audio segments corresponding to segments of the media item (pages of the book). The network server may audibly prompt the sender to indicate the page, track, or other segment being read, to read the current segment, and to include the sender's notes and anecdotes in the recording. Further, the network server may play pre-recorded prompts which guide the sender to recognize the next segment (e.g., a page in a book) to record, since not all pages in all books are numbered. These prompts may contain voice audio which includes an identifiable description of a segment (e.g., the first few words (about 5 to 8) on a page, or something recognizable in an image or video). The network server marks each audio segment recorded by the sender corresponding to each segment (e.g., page of the book) and associates the audio segment with the corresponding media item segment. Once the sender has completed recording a page, the telephony input system may provide the sender with options to review the current recording of the segment, to add an additional recorded segment (either through insertion or appendage), to cancel the recorded segment, record over with a new segment, to accept a recorded segment, and to save the current session to return later for further recording.

Once the sender has completed recording segments for each segment of the media item (e.g., page of the book), the network server synchronizes each recorded segment from the saved audio recordings of the sender's performance with the corresponding media segments, e.g., pages from the books. In one embodiment, the network server may assemble the recorded performance and the media selection into an integrated multimedia format. Completed media and audio performance combinations may be made available in several different forms. For example, the completed audio performance may be transferred to a physical medium, e.g., an audio CD, flash media, a floppy disk, or an audio tape, and a manufacturing or fulfillment center may then ship physical medium storing the recorded performance together with a tangible copy of the media, e.g., a book, as a packaged product to the recipient. In another embodiment, the recorded audio performance may be combined with the media on a multimedia CD, DVD, or video tape for physical fulfillment, or alternatively may be transmitted to a recipient as a multimedia streaming internet presentation, a telephone network accessible audio file, and other combinations.

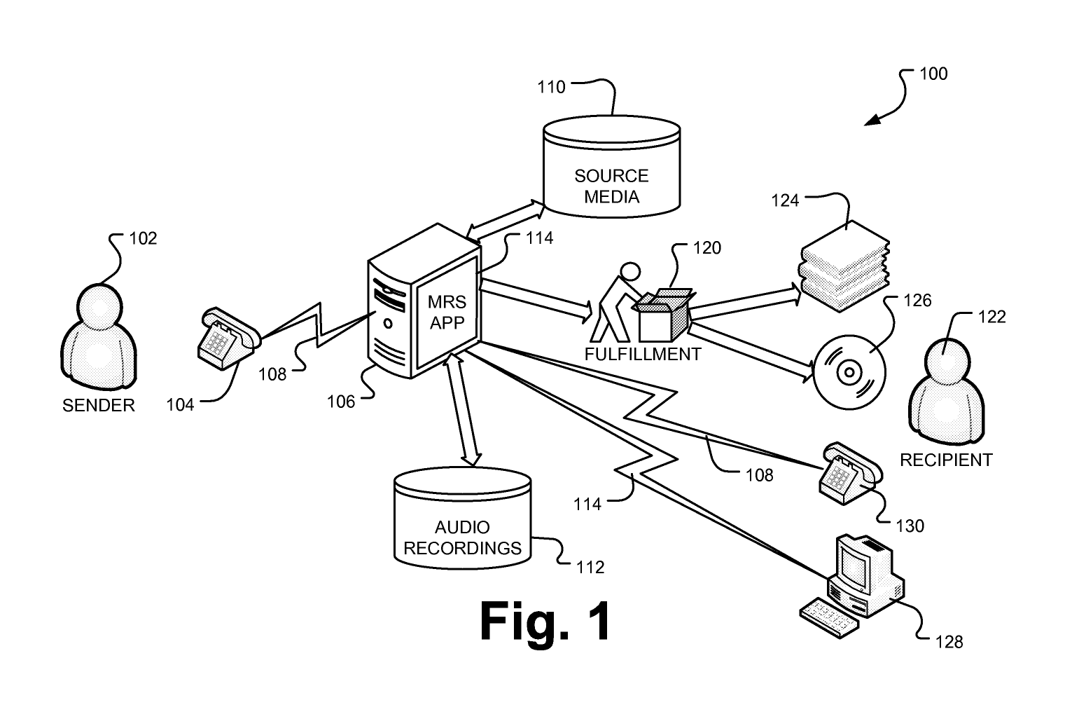

FIG. 1 depicts one exemplary implementation of a system 100 for the recording of an audio performance of a media selection across a telephone network. The sender 102 may use a telephony device 104 or other communication device to communicate with a network media server 106 over a communication network 108. The network server 106 generally connects with the communication network 108 via a network link. The telephony device 104 may be wired or wireless and capable of providing appropriate interface and connectivity functionality to communicate with the network server 106 over the telephone network 108. The telephone 104 may alternatively be any telephony device connected through a cable network, a micro-wave network, a satellite network, or a voice-over-internet-protocol (VoIP) network that may connect with a communication network 108 for a portion of the transmission.

A media recording and synchronization (MRS) application 114 may execute on the network server 106 to provide the primary functionality of the system 100. The network server 106 may further maintain or have access to one or more media repositories. A source media data repository 110, e.g., a database, may store all available media files for use by the system 100. Such media files may include electronic copies of books, music, video, and other similar forms of media. Such media files may be categorized within the media data repository 110 by one or more criteria, for example, by title, author, subject, target audience age, cost, and other similar criteria. Further, for recording an audio performance by only using a telephony device, the media repository may also include pre-recorded voice prompts which recite the first few words (perhaps 5 to 8) of each segment (e.g., pages in a book). The network server 106 may also be connected with an audio recording data repository 112 which stores audio recordings or “performances” made by multiple senders. The audio recording data repository 112 may index the audio recordings by sender name, sender identification, media title, author, date of recording, and other similar criteria. The MRS application 114 on the network server 106 provides an interface for indexing and control of reads and writes from and to the source media data repository 110 and the audio recording data repository 112.

The MRS application 114 may be designed to function as, or to interface with, the telephony device 104 to allow for simple access by a sender 102. Note, however, that this aspect of the system 100 may be implemented in a variety of different ways including, for example, in a direct client-server application format.

The network server 106 may offer a variety of media selections, for example, a selection of children's books to the sender 102 available for purchase through the communication network 108. The sender will be able to search or browse the books or other media available through the telephony device 104, select one or more media titles for purchase, and then proceed to check out via a telephone ordering system, for example, an IVR system, a touch-tone DTMF system, or some other form of telephone input system. At this point a typical electronic commerce processing platform may be used to complete the purchase of the media. This electronic commerce platform may be fully integrated in the MRS application 114 or alternatively may be an adjunct software program utilized to complete a purchase transaction. The media may then be delivered to the sender in hard copy print or electronic form.

Alternatively, the variety of media selections may be presented to the sender 102 via a traditional physical catalog or display in a store. The sender 102 may browse the available media by walking through aisles in a store or thumbing through pages in a catalogue, selecting one or more media titles, and then checking out via a mail-in order form, a telephone ordering system, a store clerk, or a web store as described above. The media may then be delivered to the sender or taken from the store in hard copy print or electronic form. Alternatively, the sender may already have in her possession a copy of one of the variety of media files of which she desires to record an audio performance using the system described herein.

Once a media selection is made and is in the sender's possession, the sender 102 may wish to prepare annotations to the media selection. These annotations may be a list of personal anecdotes, comments about the story, or a complete scripted dialogue the sender 102 wants to record for a future playback by the recipient 122. Alternatively, the sender 102 may wish to write the annotations directly into a physical copy of the media. The sender 102 may then send the personally annotated media directly to the recipient 122 or to the operator of the system described herein. The operator may package the personally annotated media with a copy of the audio performance described herein or package the personally annotated media alone for physical shipping to the recipient 122.

After the sender 102 has reviewed the media selection and has prepared or added any desired annotations, the sender may use a telephony device 104 to communicate with the network server 106 and utilize the MRS application 114 through the telephony device 104 to record audio segments corresponding to segments of the media. The network server 106 may be equipped with an IVR system, a touch-tone DTMF system, or some other form of telephone input that enables the sender 102 to select the media and record audio segments corresponding to segments of the media. The media selection may include a telephone number to access and instructions for using the MRS application 114 to record the media selection in segments. The sender 102 may progress through the media segment-by-segment (e.g., page-by-page in a book) and read the text and provide commentary for each segment that is recorded by the MRS application 114.

In one exemplary implementation, the MRS application 114 may provide tools within a IVR or touch-tone DTMF interface for allowing the sender 102 to effectuate a recording of the media selection. After the sender calls the specific telephone number associated with the network server 106 with her telephony device 104, the MRS application 114 may audibly request the sender's identity as well as the sender's media selection. The sender 102 may respond audibly and/or via touchtone selections depending on whether the MRS application 114 has IVR and/or touch-tone DTMF menu capabilities respectively. The MRS application 114 may additionally collect information regarding the recipient including name and address for delivery of a copy of the media selection and recorded audio performance.

The MRS application 114 may then begin a recording session by audibly instructing the sender 102 to first make a touch-tone selection on the telephony device 104 or say an audible command to begin recording, next read the current media segment as well as provide any additional comments or anecdotes as desired, and then make another touch-tone selection on the telephone 130 or audible command to end recording. Further, the MRS application 114 may play pre-recorded prompts which guide the sender 102 to recognize the next segment (e.g., a page in a book) to record, since not all pages in all books are numbered. These prompts may contain voice audio which includes an identifiable description of a segment, e.g., the first few words (about 5 to 8) on a page. The MRS application 114 may also be configured to begin and/or end recording after a pre-determined period of silence. The sender 102 may then progress to the next media segment of the media selection and begin another recording session on the MRS application 114 as described above.

Once a recording for a particular media segment is completed, the MRS application 114 may mark each audio segment recorded by the sender 102 by associating the audio segment with a unique identifier of the sender 102 and further associating the recorded segment with the corresponding media segment. Recording of the media selection may continue in this fashion on a segment-by-segment basis until the entire media selection has been recorded. The sender 102 may be provided with options to review the current recording for each segment before progressing to the next segment by listening to the recording via the telephone 104, to cancel the recorded segment and record a new segment, to edit a recorded segment by inserting additional comments or appending additional comments to the end of the segment, and to accept a recorded segment in order to proceed to the next segment. In addition, the MRS application 114 may allow the sender 102 to suspend and store the current recording session to return at a later time to complete the recording of the media selection.

Once a sender 102 has completed a recording of all segments for a particular media selection, the segments of the audio performance are synchronized or mapped to the corresponding segments of the media selection. Alternatively, each audio segment may be synchronized with corresponding segments of the media selection individually as the sender records. Because the sender 102 may record in segments and may further re-record some of those segments, there is a likelihood that the finished recorded performance will have different audio volumes between the sections. This variance in recording levels between recorded segments may be caused, for example, by differing positions of the telephony device's microphone, differing distances of the sender to the telephony device 104, use of a speakerphone, sender adjustment of input gain, or other disparities in the recording input. To address any inconsistencies in recording levels between segments, the MRS application 114 may incorporate editing software to ensure even sound quality and volume throughout. Such audio editing functions may be automated so that all recording segments are edited against pre-established criteria for normalization before compiling a complete recorded performance.

The MRS application 114 may further automatically annotate each recorded segment for ease of use by the recipient 122. For example, the MRS application 114 may insert pauses between recorded segments to allow a recipient 122 to move to the next media segment, e.g., turn the page of a book. Additionally, audio cues, for example, audible directions to turn to the next page, may also be inserted between the recorded audio segments. The completed recording of a media selection may then be stored in the audio recording data repository 112 for later and potentially perpetual access in a one time or on-demand fulfillment process. Alternately, the sender 102 may be given the option to record one or more custom audio cues in the sender's voice which instruct the recipient 122 to proceed to the next page. These custom audio cues, may include, for example, “Turn the page now,” or “Let's see what's next by turning the page,” or “Are you ready? Let's go to the next page!”

In one exemplary implementation, a fulfillment process 120 may be at least partially manually implemented. Once a sender's recording has been completed, the MRS application 114 may generate fulfillment instructions identifying a recipient 122 and a corresponding shipping address provided by the sender 102 and associate this recipient information with an identification of the sender's media selection and/or a related audio recording made by the sender 102. The audio recording may be automatically copied to a physical media, for example, a CD, flash storage device, or DVD, by the MRS application 114, or such a copy of the sender's recording may be initiated manually as part of the fulfillment process 120. In this implementation, a copy of the media selection, e.g., a book, and a copy of the corresponding audio recording 126, e.g., a CD or DVD, may be packaged together for shipment to the recipient 122. Upon receipt of the shipment, the recipient 122 may play the audio media 126 while simultaneously following along with a copy of the physical media 124 (e.g., a book).

In an alternate fulfillment embodiment, the recipient 122 may be notified of the availability of a media selection and corresponding audio recording prepared by the sender 102 for the recipient's benefit. Such a notification may come in the form of an electronic mail message sent by or automatic telephone call from the MRS application 114 from the network server 106 to a computing device 128 associated with the recipient 122. Alternately, the MRS application 114 may send an electronic message to another mail distribution server which, in turn, sends it to the computing device 128 associated with the recipient 122. In yet another embodiment, notification may be sent physically through the postal service or other delivery service to the recipient's shipping address. The recipient's computing device 128 may be connected with the network server 106 via a network 114, for example, the Internet (whether wired or wireless), or via a similar network.

In one embodiment of this implementation, the media selection and accompanying audio recording of the sender 102 may be sequentially served or streamed to the recipient's computing device 128 for presentation in a browser interface. Alternatively, the recipient 122 may download a complete copy of the media selection and the associated audio recording from the sender 102 for local presentation on the recipient's computing device 128. In a hybrid implementation, the media selection 124 may be manually fulfilled, e.g., by shipping a copy of a book to the recipient 122, while the audio recording of the sender 102 may be fulfilled electronically, e.g., by the recipient 122 downloading a copy of the audio file from the network server 106 to the recipient's computing device 128. The audio file may be in any known form, for example, MP3, WMV, MPEG, or other digital format, and may be played back on the recipient's computing device 128 or transferred to another playback device, e.g., an MP3 player.

In yet another implementation, the audio recording of the sender 102 may be fulfilled via the telephone network 108, e.g., by the recipient 122 using a telephone 130 to access the audio file from the network server 106. In this implementation, the media selection 124 may be manually fulfilled as well, e.g., by shipping a copy of the book to the recipient 122 or electronically fulfilled using any of the aforementioned methods.

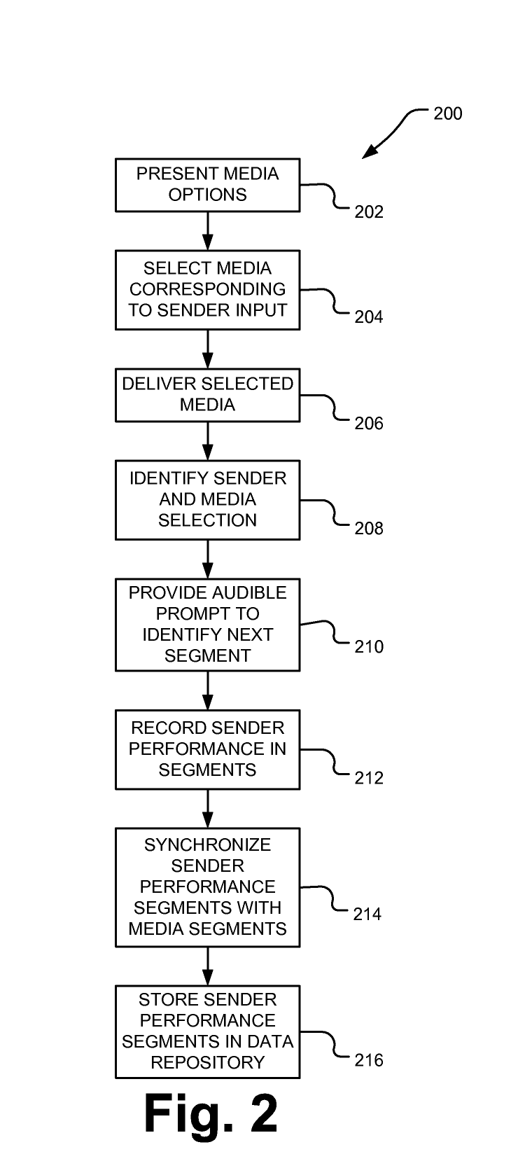

An exemplary process 200 for selecting media and recording audio of the sender across the network is depicted in FIG. 2. Initially, in a presentation operation 202, media selections, for example, a variety of books, are presented to the sender through a telephony interface. Alternatively, the variety of books may be presented to the sender via a traditional physical catalog or a display in a store. It should be understood that while this description uses the example of books, other forms of media in addition to books, for example, music (e.g., songs for karaoke singing), video (e.g., for commentary or narration), and other similar forms of media, may be presented to the sender for presentation, selection, and recording.

One or more books from the variety of books are selected in a selection operation 204. The selection is based on input from the sender through a telephony interface. The selection of books is then delivered to the sender in a delivery operation 206. The selection of books may be delivered through a postal service in various forms. Exemplary forms include printed copies of the books on loose paper, bound copies of the books and electronic copies contained within electronic media such as a CD, flash storage device, DVD, or some other portable digital media player.

The recording phase of the process 200 begins by identifying the sender and media selection in an identification operation 208. As described in more detail below, the sender and media selection may be identified by sender input through a telephony interface such as an IVR, touch-tone DTMF, or speech recognition menu. The process 200 may continue by playing pre-recorded prompts in prompting operation 210, which guide the sender to recognize the next segment (e.g., a page in a book) to record. These prompts may be in the form of prerecorded or generated voice audio which includes an identifiable description of a segment, for example, the first few words (e.g., about 5 to 8) on a page.

The sender's performance of the media selection is then recorded on a segment by segment basis as indicated in recording operation 212. The recorded segments may then be synchronized with the respective media segments in synchronizing operation 214. Each of the recorded segments may be tagged or marked with identification information to track the association of the recorded segments with a particular sender, with each other, and with the media selection and the media segments. These associations may take place through the use of database tables, file headers for each recorded segment, or other well known data indexing or identification methodologies. Each of the sender's recorded performance segments may then be stored in a database repository in storing operation 216.

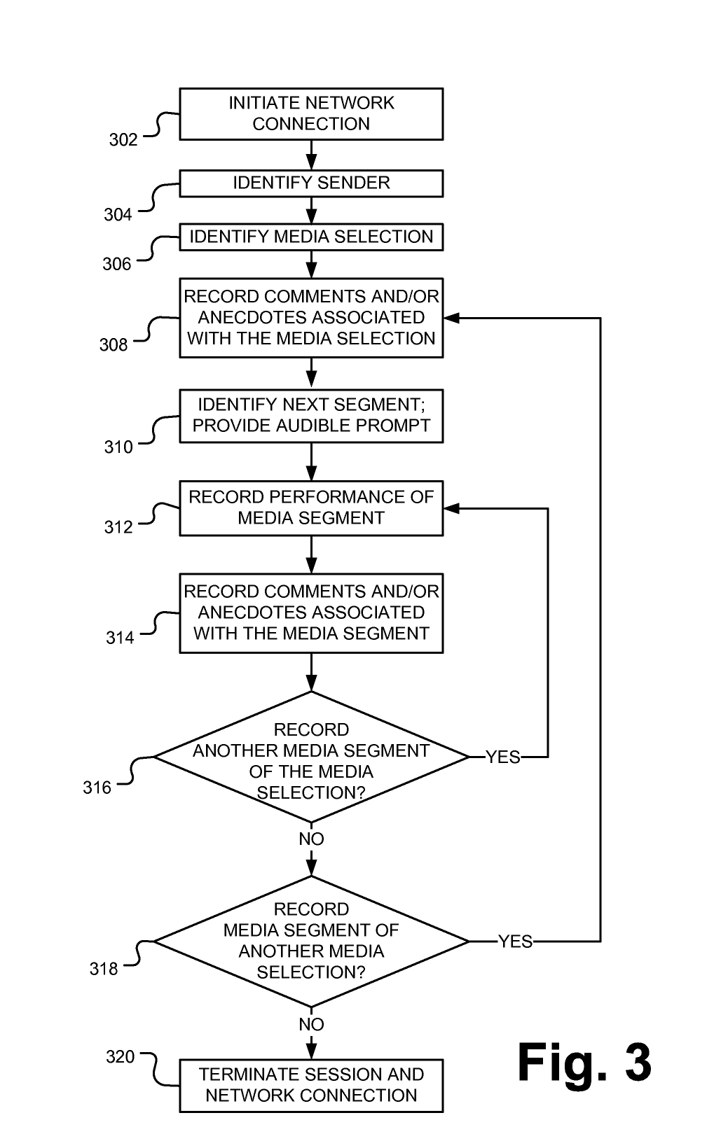

An exemplary process 300 for recording audio of the sender over a telephony device is depicted in FIG. 3. The process begins when a network connection is initiated between the sender and the network server in an initiation operation 302. This operation may be accomplished when the sender calls a specific telephone number associated with the network server and the network server answers the call, initiating the connection.

After the connection between the sender and the network server is established, the sender may be audibly presented with menu selections. The sender may be instructed that the network server utilizes an IVR system, a “touch-tone” DTMF system, or some other form of telephone input system to identify inputs from the sender. One exemplary menu option is to enter or obtain a sender identification in a sender identification operation 304. The sender may be in possession of a unique identifier assigned by the MRS application to the sender when the sender was previously presented a variety of media and made media selections. In this case, the sender may be instructed to input the unique sender identifier and the MRS application will recognize the sender's identifier and associated account though the telephone input system. In another embodiment, the sender may be provided with a unique identifier in conjunction with the purchase of the media selection. Alternatively, the sender may not be in possession of a sender identifier. In either of these cases, the sender may indicate the lack of a sender identifier and the MRS application will recognize the sender's selection through the telephone input system, assign a sender identifier to the sender, and audibly provide the sender identifier to the sender. At this time, the MRS application may create an associated account and collect sender and recipient information for contact, billing, tracking, and fulfillment purposes. In yet another embodiment, the sender's name may operate as a sender identifier.

Once the network server has identified the sender, the telephone input system menu may audibly instruct the sender to identify a media selection in a media selection operation 306. If the media selection was selected and delivered to the sender from the network server, the media selection may be assigned and marked with a unique identifier. The sender may enter the media selection identifier and the MRS application may recognize the sender's selection through the telephone input system. Alternatively, the sender may not be in possession of a unique media selection identifier because one was not provided by the network server when the media selection was selected and delivered or the sender selected and came into possession of the media selection through a source other than the network server (e.g., store purchase). In this case, the sender may use alternate information to identify the media selection, for example, the title, author, subject, and/or ISBN number of the media selection. The alternative information may be entered by the sender and recognized by the MRS application through the telephone input system.

Once the MRS application has identified the sender and the media selection, the telephone input system menu may give the sender an option to record comments and/or anecdotes generally associated with the media selection in a media selection recording operation 308. The MRS application may instruct the sender to first make a touch-tone selection or say an audible command to begin recording, record any media selection comments and/or anecdotes, and then make another touch-tone selection or say an audible command to end recording. Alternatively, the telephone input system may be configured such that recording may begin and/or end after a certain period of silence from the sender. Further, the telephone input system may give the sender the option of reviewing the comments and/or anecdotes and re-recording if the sender is unsatisfied with the previous recording.

The telephone input system menu may next audibly instruct the sender to identify a media segment of the media selection in a media segment performance operation 310. Media segments may be directly associated with page numbers, track numbers, or other identification system that identifies disparate sections of a media selection. The sender may enter the page number or other segment identification and the MRS application may recognize the sender's selection through the telephone input system. Alternately or in addition, the MRS application may play pre-recorded prompts which guide the sender to recognize the next segment (e.g., a page in a book) to record, since not all pages in all books are numbered. These prompts may contain voice audio which includes an identifiable description of a segment, for example, the first few words (e.g., about 5 to 8) on a page. The sender may then be instructed by the telephone input system to record a performance of the media segment in recording operation 312 in a manner similar to recording comments and/or anecdotes as described above.

Further, the telephone input system menu may provide the sender the option to record comments and/or anecdotes specifically associated with the media segment of the media selection in a media segment annotation operation 314. The sender may then be instructed by the telephone input system to record a performance of the comments and/or anecdotes specifically associated with the media segment in a manner similar to recording comments and/or anecdotes generally associated with the media selection as described above.

Next, the telephone input system menu may give the sender the option to record another media segment of the media selection in the next media segment operation 316. If the user chooses to record another media segment, the user repeats the media segment recording operation 312 and the media segment annotation operation 314 as described above in association with the new media segment.

The telephone input system menu may also give the sender the option to record media segments of another media selection in the next media selection operation 318. If the user chooses to record another media selection, the user repeats the media selection operation 306, the media selection recording operation 308, the media segment recording operation 312, the media segment annotation operation 314, and the next media segment operation 316 as described above in association with the new media selection.

When the sender is finished recording media segments associated with one or more media selections, the sender may elect to terminate the network connection in a network termination operation 320. The sender may indicate to the network server to terminate the connection by making a selection using the telephone input system or by simply hanging up the telephone. When the MRS application recognizes that the sender desires to terminate the network connection, the MRS application causes the network server to terminate the connection and proceeds to the synchronizing operation 214 and storing operation 216 as described above in association with FIG. 2.

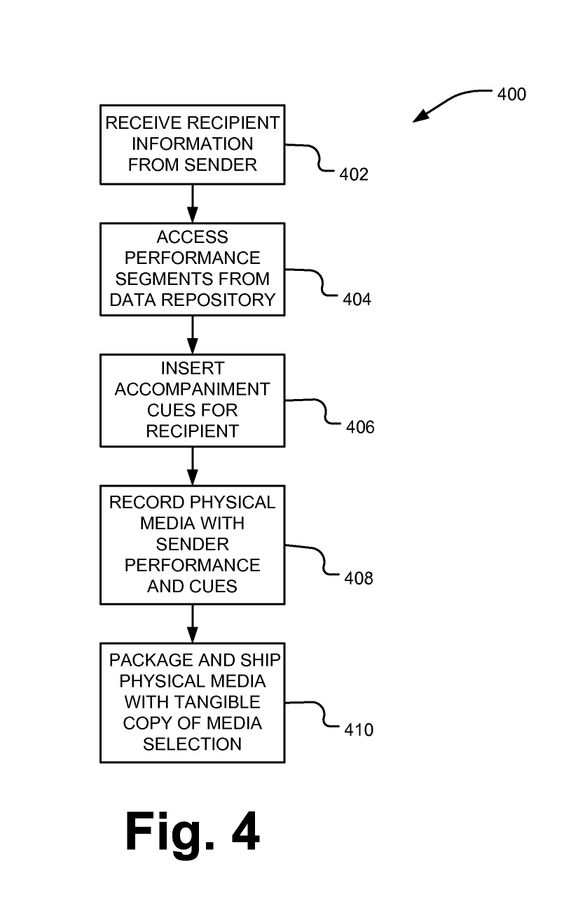

One exemplary implementation of a fulfillment process 400 for providing the recipient with copies of the sender's media selection and recorded performance are presented in FIG. 4. In order to initiate the fulfillment process 400, identification information for the recipient must be known. Such identification information may include the recipient's name, a mailing address, an e-mail address, a telephone number, or other contact information. This contact information may be received from the sender in receiving operation 402.

Once a particular recipient is identified and a media selection and recorded performance are associated with the recipient, the recorded performance segments may be accessed from the data repository in accessing operation 404. If not previously completed during the process of recording the sender's performance, accompaniment cues may be inserted between the performance segments for the benefit of the recipient as indicated in inserting operation 406. Exemplary accompaniment cues may include extended pause periods between recorded segments, for example, to allow a recipient to view pictures accompanying text on the page of a book. Other accompaniment cues may instruct the recipient to turn the page when viewing a book. Alternately, the sender may be given the option of recording one or more custom audio cues in the sender's voice which instruct the recipient to proceed to the next page. These custom audio cues, may include, for example, “Turn the page now,” or “Let's see what's next by turning the page,” or “Are you ready? Let's go to the next page!”

Once any accompaniment cues have been inserted into the performance segments, the entire performance of the sender may be recorded to a physical media for example by burning a CD or DVD with the performance data as indicated in recording operation 408, or copying the performance data to a flash memory storage media. Once a sender's performance has been recorded onto physical media, a fulfillment center may be notified to package the recorded media in conjunction with a tangible copy of the media selection of the sender, e.g., the accompanying book, and ship the package to the recipient using the contact information collected from the sender as indicated in notifying operation 410. In some implementations, the physical media and the tangible copy may be the same physical object, for example, a DVD or video tape with recorded performance accompanying the video as part of the audio track. In another implementation, the physical media may be incorporated into the tangible object, for example, a flash memory chip storing the recorded performance may be imbedded in a book with playback control buttons.

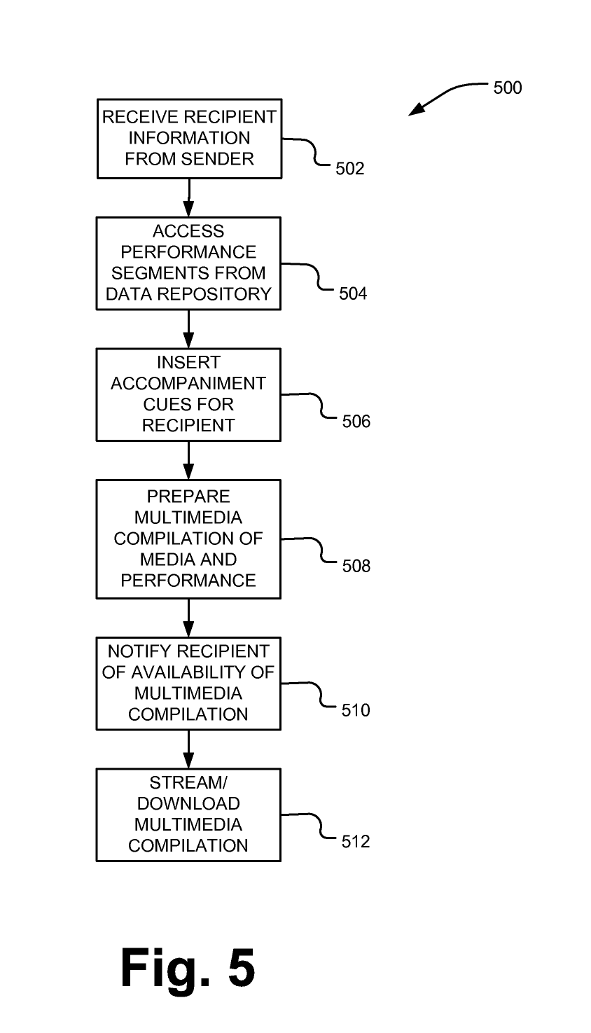

An alternate implementation of a fulfillment process 500 is depicted in FIG. 5. In order to initiate the fulfillment process 500, identification information for the recipient must be known. Such identification information may include the recipient's name, a mailing address, an e-mail address, a telephone number, or other contact information. This contact information is received from the sender in receiving operation 502.

Once a particular recipient is identified and a media selection and recorded performance are associated with the recipient, the recorded performance segments may be accessed from the data repository in accessing operation 504. If not previously completed during the process of recording the sender's performance, accompaniment cues may be inserted between the performance segments for the benefit of the recipient as indicated in inserting operation 506. Exemplary accompaniment cues may include extended pause periods between recorded segments, for example, to allow a recipient to view pictures accompanying text on the page of a book. Other accompaniment cues may instruct the recipient to turn the page when viewing a book. Alternately, the sender may be given the option of recording one or more custom audio cues in the sender's voice which instruct the recipient to proceed to the next page. These custom audio cues, may include, for example, “Turn the page now,” or “Let's see what's next by turning the page,” or “Are you ready? Let's go to the next page!”

Once any accompaniment cues have been inserted into the performance segments, a multimedia compilation of the media selection and the sender's recorded performance may be prepared in preparation of operation 508. For example, in the case of a book, bitmap images of each page of the book, including text and illustrations, may be time synchronized for display with the sender's recorded performance for that particular page of the book. Alternatively, if the selected media is a song, the sender's performance of the song may be synchronized and overlaid with the instrumental tracks of the song to create a karaoke performance. Further if the selected media is a video, the sender's commentary or narration may be synchronized with the video to create a complete multimedia compilation.

Once a multimedia compilation is complete, the recipient may be notified of the availability of the multimedia compilation as indicated in notification operation 510. This notification may be in the form of an electronic mail message sent, and/or a wireless phone “text message,” and/or an “instant” chat message, and/or a voice mail message and/or a postal service message, to an address of the recipient that is provided by the sender. Upon receipt of the notification message, a recipient may access the multimedia compilation, e.g., by selecting a hyperlink provided in the notification message or by using a browser program to navigate to a website that can provide the recipient access to the multimedia compilation. In one embodiment, the recipient may receive a copy of the media selection and the audio performance on CD by mail or shipping delivery or with instructions for accessing the audio performance via some other mode of delivery or playback. Alternatively, a recipient may access the audio component of the multimedia compilation via telephone by dialing into the network server.

Once the recipient locates the multimedia compilation, it may be presented to the user in any of several forms. For example, the user may download a file containing the multimedia compilation for playback on the recipient's computing device using standard media presentation software. Alternatively, the multimedia compilation may be presented to the user through the user's browser interface in the form of a streaming multimedia presentation. In a further implementation, fulfillment of the media selection may be performed by sending the recipient a physical copy of the media selection, e.g., a book, while the accompanying audio performance of the sender may be provided through a download of an audio file, e.g., an MP3 file, to the recipient's computing device or playback through a telephone. Playback of the audio file may be performed by recipient's computing device using standard audio player applications. Alternatively, the audio file may be copied from the recipient's computing device to an alternative playback device, for example, an MP3 player, or burned to a physical medium, e.g., a CD, for playback by the recipient using other devices then the recipient's computing device connected to the network.

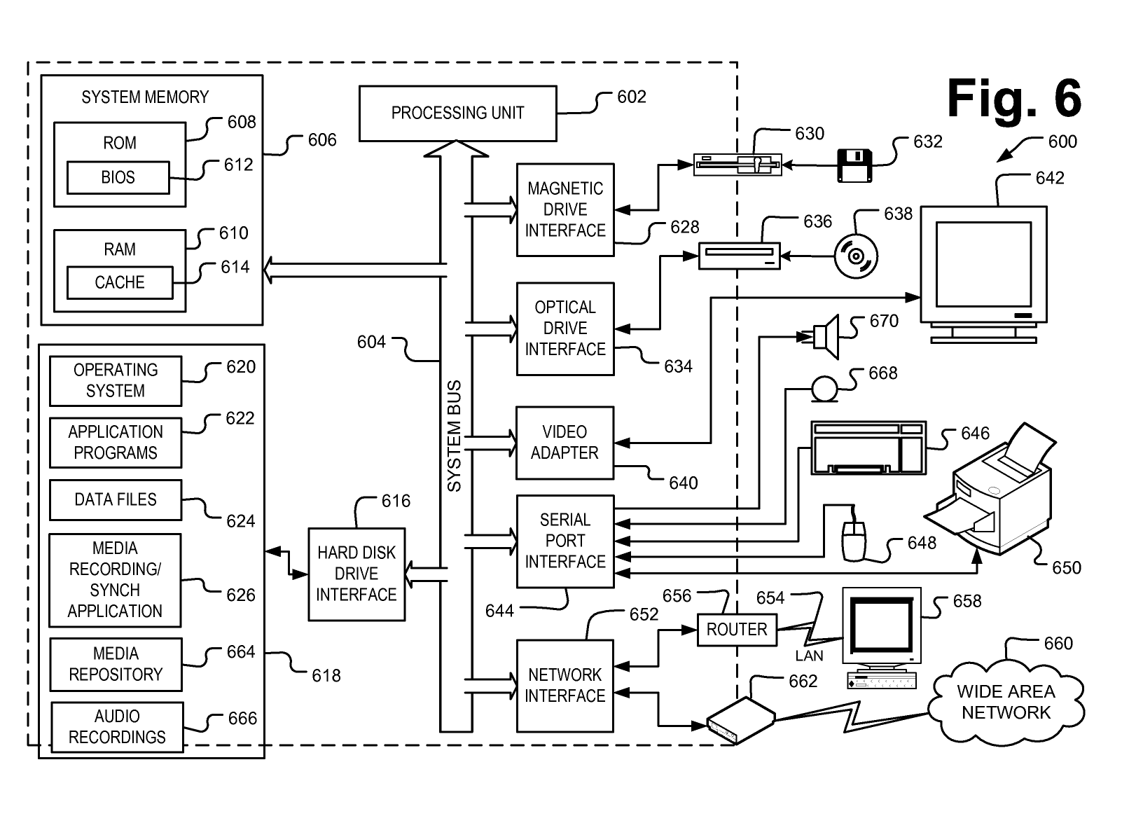

An exemplary computer system 600 for implementing the audio recording processes above is depicted in FIG. 6. The computer system 600 of a recipient may be a personal computer (PC), a workstation, a notebook or portable computer, a tablet PC, a handheld media player (e.g., an MP3 player), a smart phone device, a video gaming device, or a set top box, with internal processing and memory components as well as interface components for connection with external input, output, storage, network, and other types of peripheral devices. Internal components of the computer system in FIG. 6 are shown within the dashed line and external components are shown outside of the dashed line. Components that may be internal or external are shown straddling the dashed line. Alternatively to a PC, the computer system 600, for example, for running the MRS application, may be in the form of any of a server, a mainframe computer, a distributed computer, an Internet appliance, or other computer devices, or combinations thereof.

In any embodiment or component of the systems described herein, the computer system 600 includes a processor 602 and a system memory 606 connected by a system bus 604 that also operatively couples various system components. There may be one or more processors 602, e.g., a single central processing unit (CPU), or a plurality of processing units, commonly referred to as a parallel processing environment (for example, a dual-core, quad-core, or other multi-core processing device). The system bus 604 may be any of several types of bus structures including a memory bus or memory controller, a peripheral bus, a switched-fabric, point-to-point connection, and a local bus using any of a variety of bus architectures. The system memory 606 includes read only memory (ROM) 608 and random access memory (RAM) 610. A basic input/output system (BIOS) 612, containing the basic routines that help to transfer information between elements within the computer system 600, such as during start-up, is stored in ROM 608. A cache 614 may be set aside in RAM 610 to provide a high speed memory store for frequently accessed data.

A hard disk drive interface 616 may be connected with the system bus 604 to provide read and write access to a data storage device, e.g., a hard disk drive 618, for nonvolatile storage of applications, files, and data. A number of program modules and other data may be stored on the hard disk 618, including an operating system 620, one or more application programs 622, and data files 624. In an exemplary implementation, the hard disk drive 618 may store the media, recording, and synchronization application 626, the media data repository 664 for storage of media selections for presentation to a recipient, and the audio recording data repository 666 for storing audio performances recorded by a sender according to the exemplary processes described herein above. Note that the hard disk drive 618 may be either an internal component or an external component of the computer system 600 as indicated by the hard disk drive 618 straddling the dashed line in FIG. 6. In some configurations, there may be both an internal and an external hard disk drive 618.

The computer system 600 may further include a magnetic disk drive 630 for reading from or writing to a removable magnetic disk 632, tape, or other magnetic media. The magnetic disk drive 630 may be connected with the system bus 604 via a magnetic drive interface 628 to provide read and write access to the magnetic disk drive 630 initiated by other components or applications within the computer system 600. The magnetic disk drive 630 and the associated computer-readable media may be used to provide nonvolatile storage of computer-readable instructions, data structures, program modules, and other data for the computer system 600.

The computer system 600 may additionally include an optical disk drive 636 for reading from or writing to a removable optical disk 638 such as a CD ROM or other optical media. The optical disk drive 636 may be connected with the system bus 604 via an optical drive interface 634 to provide read and write access to the optical disk drive 636 initiated by other components or applications within the computer system 600. The optical disk drive 630 and the associated computer-readable optical media may be used to provide nonvolatile storage of computer-readable instructions, data structures, program modules, and other data for the computer system 600.

A display device 642, e.g., a monitor, a television, or a projector, or other type of presentation device may also be connected to the system bus 604 via an interface, such as a video adapter 640 or video card. Similarly, audio devices, for example, external speakers or a microphone (not shown), may be connected to the system bus 604 through an audio card or other audio interface (not shown).

In addition to the monitor 642, the computer system 600 may include other peripheral input and output devices, which are often connected to the processor 602 and memory 606 through the serial port interface 644 that is coupled to the system bus 606. Input and output devices may also or alternately be connected with the system bus 604 by other interfaces, for example, a universal serial bus (USB), an IEEE 1394 interface (“Firewire”), a parallel port, or a game port. A user may enter commands and information into the computer system 600 through various input devices including, for example, a keyboard 646 and pointing device 648, for example, a mouse. Other input devices (not shown) may include, for example, a joystick, a game pad, a tablet, a touch screen device, a satellite dish, a scanner, a facsimile machine, a telephone, a digital camera, and a digital video camera. In implementations described herein, the computer system 600 of the sender may include a microphone 668 to capture the sender's performance. Output devices may include a printer 650 and one or more loudspeakers 670 for presenting the audio performance of the sender. Other output devices (not shown) may include, for example, a plotter, a photocopier, a photo printer, a facsimile machine, a telephone, and a press. In some implementations, several of these input and output devices may be combined into single devices, for example, a printer/scanner/fax/photocopier. It should also be appreciated that other types of computer-readable media and associated drives for storing data, for example, magnetic cassettes or flash memory drives, may be accessed by the computer system 600 via the serial port interface 644 (e.g., USB) or similar port interface.

The computer system 600 may operate in a networked environment using logical connections through a network interface 652 coupled with the system bus 604 to communicate with one or more remote devices. The logical connections depicted in FIG. 6 include a local-area network (LAN) 654 and a wide-area network (WAN) 660. Such networking environments are commonplace in home networks, office networks, enterprise-wide computer networks, and intranets. These logical connections may be achieved by a communication device coupled to or integral with the computer system 600. As depicted in FIG. 6, the LAN 654 may use a router 656 or hub, either wired or wireless, internal or external, to connect with remote devices, e.g., a remote computer 658, similarly connected on the LAN 654. The remote computer 658 may be another personal computer, a server, a client, a peer device, or other common network node, and typically includes many or all of the elements described above relative to the computer system 600.

To connect with a WAN 660, the computer system 600 typically includes a modem 662 for establishing communications over the WAN 660. Typically the WAN 660 may be the Internet. However, in some instances the WAN 660 may be a large private network spread among multiple locations, or a virtual private network (VPN). The modem 662 may be a telephone modem, a high speed modem (e.g., a digital subscriber line (DSL) modem), a cable modem, or similar type of communications device. The modem 662, which may be internal or external, is connected to the system bus 618 via the network interface 652. In alternate embodiments the modem 662 may be connected via the serial port interface 644. It should be appreciated that the network connections shown are exemplary and other means of and communications devices for establishing a network communications link between the computer system and other devices or networks may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products. In one implementation, a computer program product is provided as a computer-readable medium storing an encoded computer program executable by a computer system. Another implementation of a computer program product may be provided in a computer data signal embodied in a carrier wave by a computing system and encoding the computer program. Other implementations are also described and recited herein.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method for recording an audio performance of a media selection over a communication network comprising
establishing a communication session with a sender telephony device over the communication network;
providing an interactive interface for instructing the sender to record, edit, and manage an audio performance of a media selection in segments;
receiving audio data from the sender telephony device via the communication network corresponding to audio segments of the audio performance; and
recording the audio data as a grouping of the audio segments in a first data repository to form a recorded audio performance.

2. The method of claim 1 further comprising
receiving recording instructions as DTMF tones, voice instructions, or both, from the sender telephony device over the communication network; and
controlling the recording operation, at least in part, by the recording instructions.

3. The method of claim 1 wherein the providing operation further comprises providing audible input instructions to the sender telephony device over the communication network.

4. The method of claim 1 further comprising
storing a plurality of media files in a second data repository corresponding to a plurality of media selections;
storing the recorded audio performance as one of a collection of recorded audio performances in the first data repository; and
synchronizing the recorded audio performance with a corresponding one of the media files.

5. The method of claim 4 wherein
each of the media files is formatted in media segments; and
the synchronizing operation further comprises synchronizing the audio segments with corresponding media segments.

6. The method of claim 5 further comprising
recording annotation information corresponding to a respective one of the media segments during recording of a corresponding one of the audio segments; and wherein
the synchronizing operation further comprises synchronizing the annotation information with the respective one of the media segments.

7. The method of claim 5, wherein the synchronizing operation further provides for inserting accompaniment cues into the recorded audio performance for indicating a change between media segments.

8. The method of claim 5 further comprising providing audible pre-recorded prompts to the sender telephony device over the communication network that identify a next media segment for the sender to record.

9. The method of claim 1 further comprising
copying the recorded audio performance to a storage medium; and
providing the copy of the recorded audio performance and a copy of a corresponding one of the media files to a recipient.

10. The method of claim 9, wherein the providing operation further comprises transmitting a copy of the recorded audio performance and the corresponding one of the media files to a recipient device over a communication network.

11. The method of claim 9, wherein
the storage medium is a removable physical medium;
the copy of the corresponding one of the media files is a tangible copy; and
the providing operation further comprises initiating shipping of the removable physical medium and the tangible copy to the recipient.

12. The method of claim 9, wherein
the copy of the corresponding one of the media files is a tangible copy; and
the providing operation further comprises
initiating shipping of the tangible copy to the recipient; and
transmitting the copy of the recorded audio performance over a communication network to a recipient device.

13. A computer-readable medium storing computer-readable instructions for controlling a server computer to record an audio performance of a media selection over a communication network, wherein the instructions comprise operations to
establish a communication session with a sender telephony device over the communication network;
provide an interactive interface for instructing the sender to record, edit, and manage an audio performance of the media selection in segments;
receive audio data from the sender telephony device via the communication network corresponding to audio segments of the audio performance; and
record the audio data as a grouping of the audio segments in a first data repository to form a recorded audio performance.

14. The computer readable medium of claim 13, wherein the instructions further comprise operations to
receive recording instructions as DTMF tones, voice instructions, or both, from the sender telephony device over the communication network; and
control the recording operation, at least in part, by the recording instructions.

15. The computer readable medium of claim 13, wherein the providing operation further comprises providing audible input instructions to the sender telephony device over the communications network.

16. The computer readable medium of claim 15, wherein the instructions further comprise operations to
store a plurality of media files in a second data repository corresponding to a plurality of media selections;
store the recorded audio performance as one of a collection of recorded audio performances in the first data repository; and
synchronize the recorded audio performance with a corresponding one of the media files.

17. The computer readable medium of claim 15, wherein
each of the media files is formatted in media segments; and
the synchronizing operation further comprises synchronizing the audio segments with corresponding media segments.

18. The computer readable medium of claim 13, wherein the instructions further comprise operations to
record annotation information corresponding to a respective one of the media segments during recording of a corresponding one of the audio segments; and wherein
the synchronizing operation further comprises synchronizing the annotation information with the respective one of the media segments.

19. The computer readable medium of claim 13, wherein the synchronizing operation further provides for inserting accompaniment cues into the recorded audio performance for indicating a change between media segments.

20. The computer readable medium of claim 12, wherein the instructions further comprise operations to provide audible pre-recorded prompts to the sender telephony device over the communication network that identify a next media segment for the sender to record.

21. The computer readable medium of claim 13, wherein the instructions further comprise operations to
copy the recorded audio performance to a storage medium; and
provide the copy of the recorded audio performance and a copy of a corresponding one of the media files to a recipient.

22. The computer readable medium of claim 21, wherein the instructions for the providing operation further comprise an operation to
transmit a copy of the recorded audio performance and the corresponding one of the media files to a recipient device over a communication network.

23. The computer readable medium of claim 21, wherein
the storage medium is a removable physical medium;
the copy of the corresponding one of the media files is a tangible copy; and
the instructions for the providing operation further comprise an operation to initiate shipping of the removable physical medium and the tangible copy to the recipient.

24. The computer readable medium of claim 21, wherein
the copy of the corresponding one of the media files is a tangible copy; and
the instructions for the providing operation further comprise operations to
initiate shipping of the tangible copy to the recipient; and
transmit the copy of the recorded audio performance over a communication network to a recipient device.

25. A system for recording an audio performance of a media selection over a communication network comprising
a first data repository for storing a collection of audio performances;
a communication network link to a sender telephony device over a communication network; and
a voice server configured to
provide an interactive interface for instructing the sender to record, edit, and manage an audio performance of a media selection in segments via the communication network link;
receive audio data from a sender telephony device via the communication network corresponding to audio segments of the audio performance; and
record the audio data as a grouping of the audio segments in the first data repository to form a recorded audio performance corresponding to the media selection.

26. The system of claim 25, wherein the voice server is further configured to
receive recording instructions as DTMF tones generated by the sender telephony device, voice instructions input in the sender telephony device, or both, over the communication network; and
control the recording operation, at least in part, by the recording instructions.

27. The system of claim 25, wherein the interactive interface further comprises audible input instructions to the sender telephony device over the communication network

28. The system of claim 25 further comprising
a second data repository; and wherein
the voice server is further configured to
store a plurality of media files in the second data repository corresponding to a plurality of media selections;
store the recorded audio performance as one of the collection of recorded audio performances in the first data repository; and
synchronize the recorded audio performance with a corresponding one of the media files.

29. The system of claim 28, wherein
each of the media files is formatted in media segments; and
the voice server is further configured to synchronize the recorded audio performance with a corresponding one of the media files by synchronizing the audio segments with corresponding media segments.

30. The system of claim 29, wherein the voice server is further configured to
record annotation information corresponding to a respective one of the media segments during recording of a corresponding one of the audio segments; and
synchronize the annotation information with the respective one of the media segments.

31. The system of claim 29, wherein the voice server is further configured to insert accompaniment cues into the recorded audio performance for indicating a change between media segments.

32. The system of claim 29, wherein the voice server is further configured to provide audible pre-recorded prompts to the sender telephony device over the communication network that identify a next media segment for the sender to record.

33. The system of claim 25, wherein the voice server is further configured to
copy the recorded audio performance to a storage medium; and
provide the copy of the recorded audio performance and a copy of a corresponding one of the media files to a recipient.

34. The system of claim 33, wherein the voice server is further configured to transmit a copy of the recorded audio performance and the corresponding one of the media files to a recipient device over a communication network.

35. The system of claim 33, wherein
the storage medium is a removable physical medium;
the copy of the corresponding one of the media files is a tangible copy; and
the voice server is further configured to initiating ship of the removable physical medium and the tangible copy to the recipient.

36. The system of claim 33, wherein
the copy of the corresponding one of the media files is a tangible copy; and
the voice server is further configured to
initiate shipping of the tangible copy to the recipient; and
transmit the copy of the recorded audio performance over a communication network to a recipient device.
